(19) United States
(12) Patent Application Publication
(10) Pub. No.: US 2026/0112282 A1
(43) Pub. Date: Apr. 23, 2026

(54) WIRELESS HEADSET TEACHING SYSTEM FOR ENVIRONMENTS THAT INHIBIT COMMUNICATION

(71) Applicant: Natalio Cortez, Humble, TX (US)

(72) Inventor: Natalio Cortez, Humble, TX (US)

(21) Appl. No.: 18/923,970

(22) Filed: Oct. 23, 2024

(51) Int. Cl. G09B 5/04; G06F 3/16; H04R 1/10; H04R 3/12

(52) U.S. Cl. CPC G09B 5/04; G06F 3/165; H04R 1/1008; H04R 1/1025; H04R 1/1041; H04R 1/105; H04R 1/1083; H04R 3/12; H04R 2420/07; H04R 2430/01; H04R 2460/01

(57) ABSTRACT

A wireless headset teaching system for environments that inhibit communication includes a plurality of headsets and a computer application. Each of the plurality of headsets includes a frame to be placed on and about a lower head or upper neck portion of a person, a speaker, a microphone, a wireless transceiver, a microprocessor, and a rechargeable battery. The plurality of headsets are designed to be synced together wirelessly for transfer of audio and to permit control by an instructor. The computer application is storable on a portable electronic device to be operatively connected to one of the plurality of headsets worn by an instructor and synced to others of the plurality of headsets worn by students to permit control thereof.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to wireless headsets and more particularly pertains to a new wireless headset teaching system for use in environments that inhibit communication. There are often situations in which it is desirable to communicate with multiple people but it is difficult to properly communicate with the group due to excessive background noise or distance between the persons and speaker. This can especially be the situation in teaching environments, where the instructor is trying to effectively communicate with multiple students. For example, one type of teaching environment is the industrial arts, such as automotive repair, welding, machining, carpentry, and other such technologies where the students are working in a large space with possibly very loud equipment. In welding, for example, the students are wearing welding masks that can inhibit visual and auditory communication, are often far from the instructor, and the machinery and metal being handled produce considerable background noise. The wireless headset teaching system allows the instructor to communicate directly with the students, and vice versa, with sufficient volume and clarity so everyone is heard and understood despite the different factors present.

### (2) Description of Related Art Including Information Disclosed Under 37 CFR 1.97 and 1.98

The prior art relates to wireless headsets. The prior art, as best understood, does not disclose a wireless headset teaching system for environments that inhibit communication that includes a plurality of headsets and a computer application, wherein the headsets are designed to be synced together wirelessly for transfer of audio and to permit control by an instructor via the computer application that is storable on a portable electronic device operatively connected to a headset worn by the instructor.

### BRIEF SUMMARY OF THE INVENTION

An embodiment of the disclosure meets the needs presented above in a wireless headset teaching system generally comprising a plurality of headsets and a computer application. Each of the plurality of headsets includes a frame to be placed on and about a lower head or upper neck portion of a person, a speaker, a microphone, a wireless transceiver, a microprocessor, and a rechargeable battery. The plurality of headsets are designed to be synced together wirelessly for transfer of audio and to permit control by an instructor. The computer application is storable on a portable electronic device to be operatively connected to one of the plurality of headsets worn by an instructor and synced to others of the plurality of headsets worn by students to permit control thereof.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a wireless headset teaching system according to an embodiment of the disclosure.

FIG. 2 is a perspective view of an embodiment of the disclosure.

FIG. 3 is a close-up view of a portion of an embodiment of the disclosure.

FIG. 4 is a perspective view of a component of an embodiment of the disclosure.

FIG. 5 is a perspective view of a component of an embodiment of the disclosure.

FIG. 6 is a close-up view of a portion of an embodiment of the disclosure.

FIG. 7 is a perspective view of an embodiment of the disclosure.

FIG. 8 is a side view of an embodiment of the disclosure in use.

FIG. 9 is a block diagram of components of an embodiment of the disclosure.

### DETAILED DESCRIPTION OF THE INVENTION

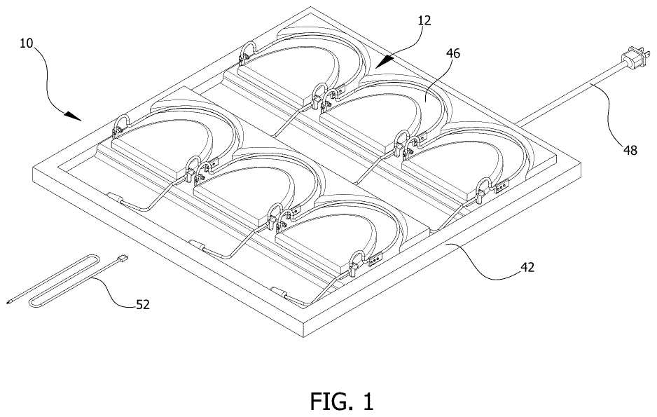

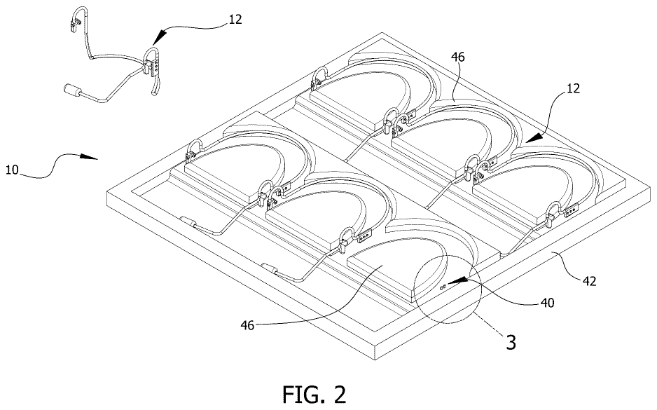

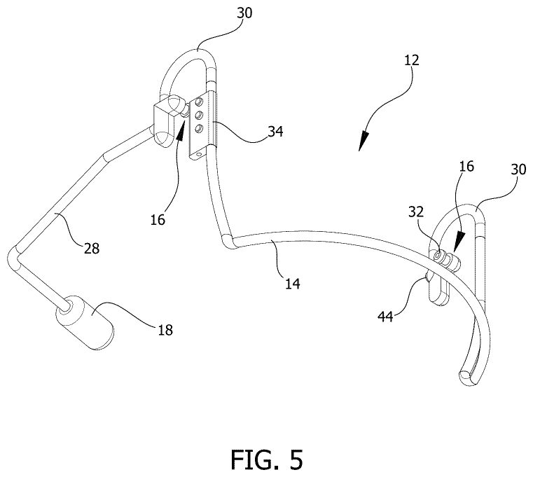

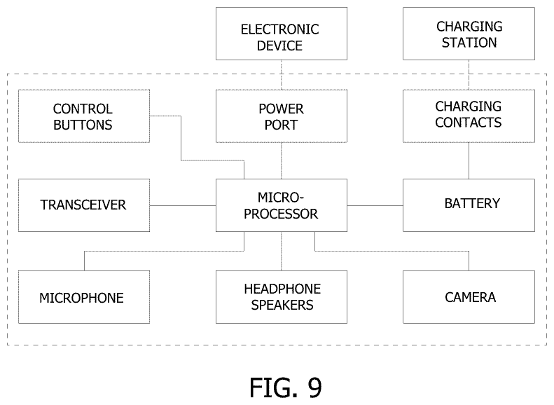

With reference now to the drawings, and in particular to FIGS. 1 through 9 thereof, a new wireless headset teaching system embodying the principles and concepts of an embodiment of the disclosure and generally designated by the reference numeral 10 will be described.

As best illustrated in FIGS. 1 through 9, the wireless headset teaching system 10 generally comprises a plurality of headsets 12 and a computer application. Each of the plurality of headsets 12 includes a frame 14 to be placed on and about a lower head or upper neck portion of a person, a speaker 16, a microphone 18, a wireless transceiver 20, a microprocessor 22, and a rechargeable battery 24. The plurality of headsets 12 are designed to be synced together wirelessly for transfer of audio and to permit control by an instructor. The computer application is storable on a portable electronic device 26 to be operatively connected to one of the plurality of headsets 12 worn by an instructor and synced to others of the plurality of headsets 12 worn by students to permit control thereof.

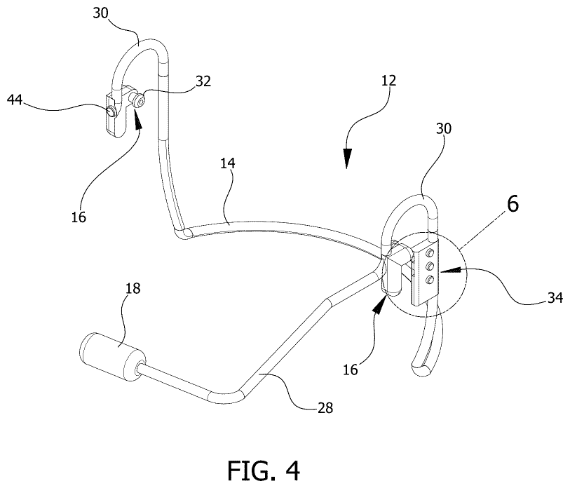

FIG. 4 shows an exemplary embodiment of a possible design of the headsets 12, though it should be understood that variations based on known headset or headphone designs are within the scope of the disclosure. As shown in FIG. 4, the microphone 18 includes a boom arm 28 connected to the frame 14. The frame 14 includes curved portions 30 designed to wrap around the ears of a person. The speaker 16 includes a non-invasive earpiece 32. In other words, the earpiece 32 is designed not to project too far into the ear canal to minimize buildup of earwax and facilitate cleaning since the headsets 12 will be used in a classroom setting by multiple students and instructors. The headset 12 in this embodiment includes a pair of the speakers 16, one for each ear of a wearer. The frame 14 includes a control portion 34 that has control buttons 36, such as a sync button, a volume button, and a noise cancellation button, though other buttons and controls are within the scope of the disclosure. The control portion 34 includes charging contacts 38 operatively connected to the battery 24 and designed to magnetically engage with corresponding base contacts 40 on a charging case 42, as will be discussed further below. Each of the plurality of headsets 12 can also be designed to include a camera 44 to record video.

The computer application is designed to perform multiple control functions, some of which are disclosed herein but should not be considered as limiting the possible control functions. The computer application can permit an instructor to selectively mute and unmute one or more of the microphones 18. The computer application can also permit an instructor to selectively adjust audio volume of one or more of the speakers 16. The computer application can also permit an instructor to store at least one of audio and video transmitted through the plurality of headsets 12. Other control functions are within the scope of the disclosure, such as turning on and off video.

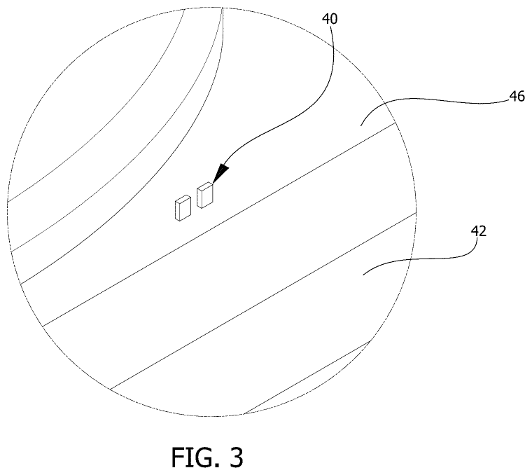

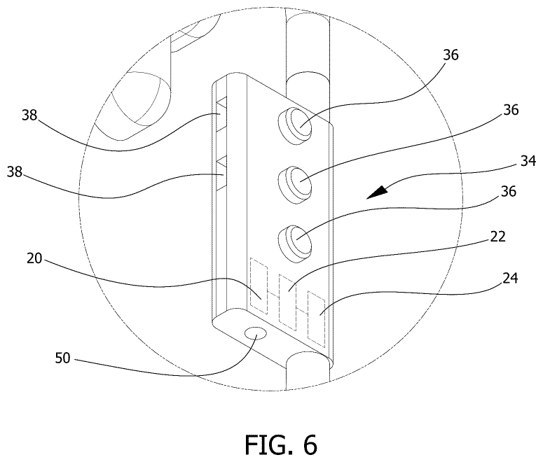

In one possible embodiment shown in FIGS. 1 through 3, the wireless headset teaching system 10 further includes a charging case 42 that is portable and designed to store and charge the plurality of headsets 12. The charging case 42 includes a plurality of headset receptacles 46 and base contacts 40 designed to magnetically engage with the charging contacts 38, and wherein the charging case 42 includes a power cord 48. A shown in FIG. 3, the base contacts 40 are part of the charging case 42 and project outwardly. As shown in FIG. 6, the charging contacts 38 of the headsets 12 are in the form of receptacles designed to engage with the base contacts 40. However, this is only an exemplary embodiment and other designs of the base contacts 40 and charging contacts 38 are well within the scope of the disclosure.

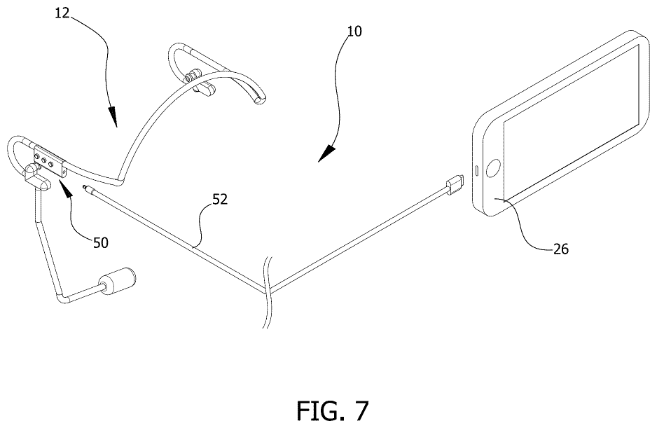

While the wireless headset teaching system 10 could be used with a personal portable electronic device 26, such as a smartphone, tablet computer, or laptop computer, in one possible embodiment the wireless headset teaching system 10 further includes a portable electronic device 26 having the computer application thereon and a cable to connect the portable electronic device 26 to one of the plurality of headsets 12 worn by an instructor. As shown in FIGS. 6 and 7, a port 50 is included in the control portion 34 to permit connection with the cable 52, which could be a USB connector or similar data wire. In this possible embodiment, the portable electronic device 26 could be a small phone-like unit that has an interface, such as a touchscreen, to permit the instructor to operate the computer application, which would essentially be the only program on the portable electronic device 26.

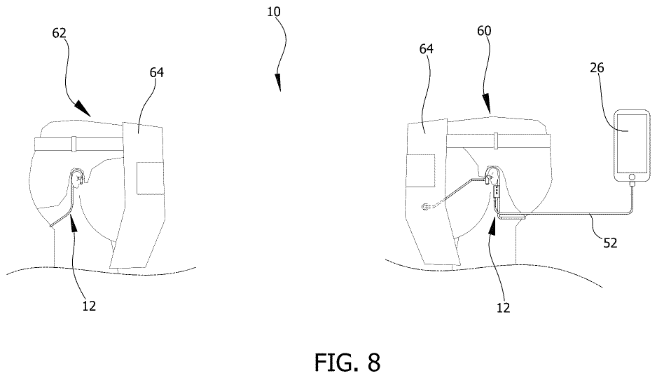

FIG. 8 shows the use of the wireless headset teaching system 10 in a welding instruction setting. Both the instructor 60 and the student 62 are wearing welding masks 64, which generally go over the face but can also extend back over the ears to make hearing very difficult in addition to the substantial noise. The instructor 60 and the student 62 are wearing headsets 12 that are synced together, as well as with other students. The headset 12 of the instructor 60 is connected to the portable electronic device 26. The instructor 60 can now use the computer application on the portable electronic device 26 to do such things as mute the microphones 18 of the students 62 so that background noise and talking will not interfere with instruction. The instructor 60 can also unmute the microphones 18, either individually or all at once, to permit the students 62 to participate by asking questions and discussing concepts. The computer application can allow for multiple different control options to optimize communication and improve learning.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wireless headset teaching system for environments that inhibit communication comprising:
a plurality of headsets each comprising a frame to be placed on and about a lower head or upper neck portion of a person, a speaker, a microphone, a wireless transceiver, a microprocessor, and a rechargeable battery, wherein said plurality of headsets are configured to be synced together wirelessly for transfer of audio and to permit control by an instructor; and
a computer application storable on a portable electronic device to be operatively connected to one of said plurality of headsets worn by an instructor and synced to others of said plurality of headsets worn by students to permit control thereof.

2. The wireless headset teaching system of claim 1, wherein said computer application is configured to permit an instructor to selectively mute and unmute one or more of said microphones.

3. The wireless headset teaching system of claim 1, wherein said computer application is configured to permit an instructor to selectively adjust audio volume of one or more of said speakers.

4. The wireless headset teaching system of claim 1, wherein said computer application is configured to permit an instructor to store audio transmitted through said plurality of headsets.

5. The wireless headset teaching system of claim 1, wherein each of said plurality of headsets comprises a camera to record video.

6. The wireless headset teaching system of claim 5, wherein said computer application is configured to permit an instructor to store video transmitted through said plurality of headsets.

7. The wireless headset teaching system of claim 1, wherein said microphone comprises a boom arm connected to said frame.

8. The wireless headset teaching system of claim 1, wherein said frame comprises curved portions configured to wrap around ears of a person.

9. The wireless headset teaching system of claim 1, wherein said speaker comprises a non-invasive earpiece.

10. The wireless headset teaching system of claim 1, wherein each of said plurality of headsets comprises a pair of said speakers, one for each ear of a wearer.

11. The wireless headset teaching system of claim 1, wherein said frame comprises a control portion comprising a sync button, a volume button, and a noise cancellation button.

12. The wireless headset teaching system of claim 1, wherein said control portion comprises charging contacts operatively connected to said battery and configured to magnetically engage with corresponding base contacts on a charging case.

13. The wireless headset teaching system of claim 12, wherein the wireless headset teaching system further comprises a charging case being portable and configured to store said plurality of headsets.

14. The wireless headset teaching system of claim 13, wherein said charging case comprises a plurality of headset receptacles and base contacts configured to magnetically engage with said charging contacts.

15. The wireless headset teaching system of claim 14, wherein said charging case comprises a power cord.

16. The wireless headset teaching system of claim 1, wherein the wireless headset teaching system further comprises a portable electronic device having said computer application thereon and a cable to connect said portable electronic device to one of said plurality of headsets worn by an instructor, wherein said portable electronic device has an interface to permit the instructor to operate said computer application.

17. A wireless headset teaching system for environments that inhibit communication comprising:
a plurality of headsets each comprising a frame to be placed on and about a lower head or upper neck portion of a person, a speaker, a microphone, a wireless transceiver, a microprocessor, and a rechargeable battery, wherein said plurality of headsets are configured to be synced together wirelessly for transfer of audio and to permit control by an instructor, and wherein:
said microphone comprises a boom arm connected to said frame;
said frame comprises curved portions configured to wrap around ears of a person;
said speaker comprises a non-invasive earpiece;
each of said plurality of headsets comprises a pair of said speakers, one for each ear of a wearer;
said frame comprises a control portion comprising a sync button, a volume button, and a noise cancellation button;
said control portion comprises charging contacts operatively connected to said battery and configured to magnetically engage with corresponding base contacts on a charging case;
each of said plurality of headsets comprises a camera to record video; and
a computer application storable on a portable electronic device to be operatively connected to one of said plurality of headsets worn by an instructor and synced to others of said plurality of headsets worn by students to permit control thereof, wherein:
said computer application is configured to permit an instructor to selectively mute and unmute one or more of said microphones;
said computer application is configured to permit an instructor to selectively adjust audio volume of one or more of said speakers;
said computer application is configured to permit an instructor to store at least one of audio and video transmitted through said plurality of headsets.

18. The wireless headset teaching system of claim 17, wherein the wireless headset teaching system further comprises a charging case being portable and configured to store said plurality of headsets, wherein said charging case comprises a plurality of headset receptacles and base contacts configured to magnetically engage with said charging contacts, and wherein said charging case comprises a power cord.

19. The wireless headset teaching system of claim 18, wherein the wireless headset teaching system further comprises a portable electronic device having said computer application thereon and a cable to connect said portable electronic device to one of said plurality of headsets worn by an instructor, wherein said portable electronic device has an interface to permit the instructor to operate said computer application.

20. The wireless headset teaching system of claim 17, wherein the wireless headset teaching system further comprises a portable electronic device having said computer application thereon and a cable to connect said portable electronic device to one of said plurality of headsets worn by an instructor, wherein said portable electronic device has an interface to permit the instructor to operate said computer application.
